(19) United States
(12) Patent Application Publication
(10) Pub. No.: US 2024/0153206 A1
(43) Pub. Date: May 9, 2024

(54) GENERATING THREE-DIMENSIONAL DATA MODELS OF TWO-DIMENSIONAL FLOOR PLANS

(71) Applicant: BRITISH TELECOMMUNICATIONS PUBLIC LIMITED COMPANY, London (GB)

(72) Inventors: Anasol PENA-RIOS, London (GB); Anthony CONWAY, London (GB); Gilbert OWUSU, London (GB); Hugo LEON GARZA, London (GB); Hani HAGRAS, London (GB)

(21) Appl. No.: 18/550,614

(22) PCT Filed: Mar. 10, 2022
(86) PCT No.: PCT/EP2022/056223

§ 371 Date: Sep. 14, 2023

(30) Foreign Application Priority Data
Mar. 16, 2021 (GB) 2103656.1

(51) Int. Cl. G06T 17/00; G06V 10/44; G06V 10/762; G06V 10/774; G06V 20/70; G06V 30/413; G06V 30/422

(52) U.S. Cl. CPC G06T 17/00; G06V 10/44; G06V 10/762; G06V 10/774; G06V 20/70; G06V 30/413; G06V 30/422; G06T 2210/04

(57) ABSTRACT

A computer implemented method to generate a three-dimensional (3D) data model of a two-dimensional (2D) floor plan, the floor plan being constituted as a digital image including indications of types of building elements, is disclosed.

### PRIORITY CLAIM

The present application is a National Phase entry of PCT Application No. PCT/EP2022/056223, filed Mar. 10, 2022, which claims priority from GB Patent Application No. 2103656.1, filed Mar. 16, 2021, each of which is hereby fully incorporated herein by reference.

### TECHNICAL FIELD

The present disclosure relates to the generation of three-dimensional data models for two dimensional floor plans.

### BACKGROUND

Two-dimensional (2D) floor plans are conventionally provided for infrastructure including buildings and other physical assets. More recently, rich three-dimensional (3D) models are provided including a specification of the layout, arrangement or configuration of a space in three dimensions. Such 3D models are especially useful when planning infrastructure design and rollout such as power management, computer or other network planning, plumbing, services and the like.

For example, Building Information Modelling (BIM) provides for the generation and management of digital representations of physical and functional characteristics of places, including in 3D. For example, Industry Foundation Classes (IFCs) can be used to define rich 3D models in IFC file formats as part of BIM.

A challenge arises where only 2D floor plans are available for existing infrastructure such as legacy buildings and/or infrastructure developed prior to the availability of 3D models. It is desirable to address this challenge.

### SUMMARY

According to a first aspect of the present disclosure, there is provided a computer implemented method to generate a three-dimensional (3D) data model of a two-dimensional (2D) floor plan, the floor plan being constituted as a digital image including indications of types of building elements, the method comprising: training a classifier to classify each pixel in each of a plurality of portions of the floor plan to a type of building element, the classifier being defined based on a training set of 2D floor plan images by extracting features for each of a plurality of portions of each image and clustering the features to labelled clusters, each label indicating a type of building element, wherein training the classifier further comprises defining a plurality of rules defining relationships between pixels in portions of a plan to each cluster by a degree of membership, the relationships being determined based on executing the rules for pixels in portions of the training set; receiving 2D floor plan; classifying pixels in the received floor plan to types of building element based on the trained classifier by executing the rules for each pixel of each of a plurality of portions of the received floor plan to classify the pixel as a type of building element; associating parts of the received 2D floor plan with each of a plurality of types of building element by identifying groups of pixels classified as the type of building element; and generating a 3D data model indicating 3D building elements based on the classification of each pixel in the received 2D floor plan.

In some embodiments, floor plan further includes indications of objects located within a building represented by the floor plan.

In some embodiments, the 3D data model is constituted as a data file formatted according to the International Foundation Classes (IFC) format.

In some embodiments, the 3D data model is used to define a Building Information Model (BIM).

In some embodiments, the method further comprises rendering the 3D data model by an extended reality system including one or more of: a virtual reality system; an augmented reality system; and a mixed reality system.

In some embodiments, the types of building element include: wall; window; and door.

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF THE DRAWINGS

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of an arrangement for generating a three-dimensional (3D) data model of a two-dimensional (2D) floor plan according to embodiments of the present disclosure.

FIG. 3 is a flowchart of a method for generating a three-dimensional (3D) data model of a two-dimensional (2D) floor plan according to embodiments of the present disclosure.

### DETAILED DESCRIPTION

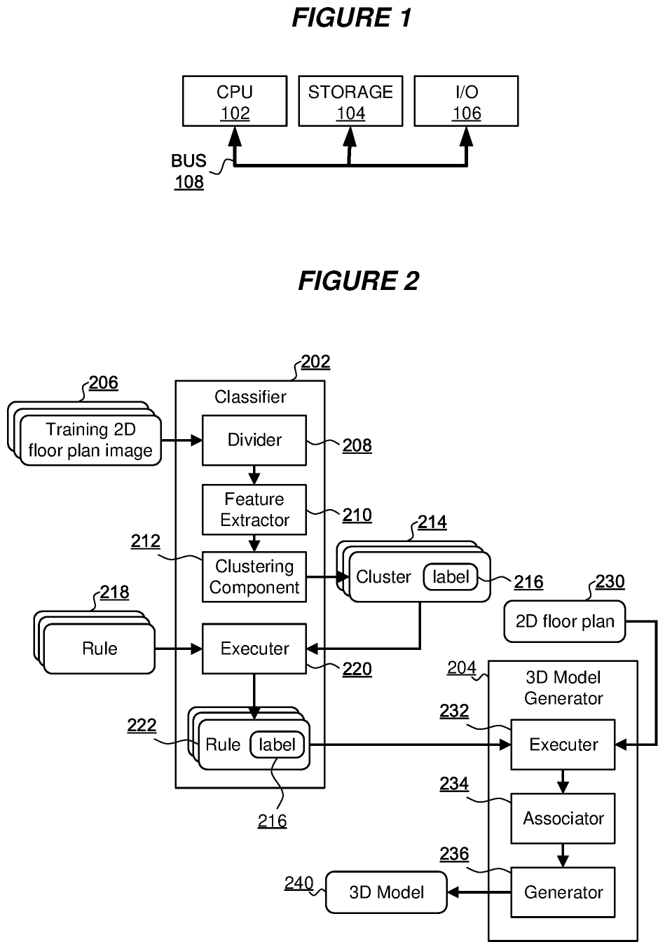

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

Embodiments of the present disclosure provide for the generation of a 3D data model of a 2D floor plan. The floor plan is provided as a digital image such as a plan defined in a digital image whether vector or raster, or a scanned floorplan such as a scanned digital image representation of a physical floor plan. A classifier is trained based on multiple training floor plans, each being a digital image, by processing each training floor plan. Each training floor plan is processed as a series of equally-sized portions of each image such as patches of each image. A feature extraction process is applied to each portion and the features of the portion are represented in a feature data structure such as a feature vector. The features for each portion for all images are subsequently clustered using a clustering algorithm such that each cluster can be labelled according to a type of building element predominantly represented by the cluster. For example, building elements can include walls, windows, doors etc. In some embodiments, the floor plan can further indicate objects located within a building such as equipment, machinery and the like. Such labelling can be supervised in the sense that it can be informed by expert input, for example, or it can itself be the product of a trained machine learning algorithm. Subsequently, a set of rules is defined, each rule defining a relationship between pixels in portions of a plan and each cluster by a degree of membership, such as a fuzzy-logic relationship. The rules are associated with each cluster based on processing of pixels of the training plans so as to define the relationships between pixels and each cluster. Thus, each rule is associated with a label for a type of building element based on the associated cluster for the rule.

Subsequently, embodiments of the present disclosure classify pixels in a received 2D floor plan to building elements based on the classifier so that parts of the received floorplan can be associated with types of building element on which basis a 3D data model can be generated.

FIG. 2 is a component diagram of an arrangement for generating a three-dimensional (3D) data model of a two-dimensional (2D) floor plan according to embodiments of the present disclosure. The arrangement includes a classifier 202 as a hardware, software, firmware or combination component suitable for training to classify each pixel in each of a plurality of portions of a floor plan to a type of building element. The classifier includes a divider component 208 as a functional software, firmware or hardware component for receiving a plurality of training 2D floor plan images 206 and dividing each image into a plurality of fixed-size portions. The size of each portion can be predefined and the portions may or may not overlap. The classifier 202 further includes a feature extractor 210 component for extracting features from each portion of a training 2D image so as to generate a representation of features of the portion. For example, the feature extractor 210 can generate a feature vector for the portion of the image using, for example, Principal Component Analysis (PCA) as is known to those skilled in the art. By way of example, PCA applied to image data is described in the paper “The Principal Component Analysis Method Based Descriptor for Visual Object Classification” (Kurt et al, International Journal of Intelligent Systems and Applications in Engineering, September 2015).

A clustering component 212 is provided to process a feature representation extracted by the feature extractor 210 for each portion of each training image 206 by clustering the feature representations into a plurality of clusters 214. For example, a k-means clustering technique can be applied by the clustering component 212. The clusters 214 thus constitute, indicate or refer to clusters of portions of the training images 206. Each cluster 214 is labelled 216 indicating a type of building element represented by the cluster 214, such as a building element predominantly represented by the cluster. For example, a cluster that predominantly represents a wall is labelled to identify a wall. The label 216 for each cluster 214 can be determined by expert input such as by an expert analyzing each portion of each training image to apply an appropriate label. Alternatively, the label 216 for each cluster 214 can be determined at least partly based on a machine learning process such as a supervised machine learning algorithm trained to classify portions of floor plan images as building elements.

A set of rules 218 is provided each defining a relationship between a pixel in a plan and a cluster 214 in the set of clusters 214 so as to associate each rule 218 with a label by way of a label associated with the cluster to which the rule relates. The rules can be based on fuzzy relations between a pixel, a portion of a plan containing the pixel, and a label for a type of building element. For example, an exemplary rule for a pixel (current_pixel) in a portion (current_portion) of an input floor plan digital image specifies:
“IF current_portion is very similar to the cluster labelled wall AND pixel_intensity for the current_pixel is high THEN label the pixel as wall”.

Notably, the similarity between a portion in the input floor plan and a cluster 214 can be determined by performing the feature extraction process to the portion and applying the clustering algorithm to the extracted features of portion to measure similarity (e.g. proximity) to the cluster 214, such as based on a degree of association of the extracted features and the cluster.

Further notably, the rules can be based on fuzzy relations such that membership to fuzzy classes can be defined using a fuzzy-logic classification scheme. Thus, for example, the determination that a portion is very similar to a cluster can be defined as one of a plurality of fuzzy classes of association such as: dissimilar, similar, and very similar. Further such fuzzy-logic classifications to be applied to other aspects of rules such as pixel intensity.

The classifier 202 further includes an executer component 220 operable to determine, for each rule 218, a label 216 corresponding to a type of building element for association with the rule 222. The label 216 for a rule is determined by executing each rule 218 for each of at least a subset of portions of each of at least a subset of training images 206. Thus, where a portion processed by a rule 218 satisfies the rule then a label 216 for a cluster with which the portion is associated is associated with the rule 218 to form a labelled rule 222. Notably, where multiple labels are identified for a rule then a differentiating process can be employed to select one label such as by selecting a label most frequently associated with the rule.

Further notably, the rules 218 can be defined exhaustively to cover all combinations of pixel intensity, fuzzy relation, and cluster 214. In such embodiments, filtering of the rules is achieved by the executer component 220 by removing or excluding all rules 218 that are not associated with a cluster 214.

Thus, the classifier 202 is operable to generate a labelled set of rules 222. The arrangement of FIG. 2 further includes a 3D model generator component 204 as a hardware, firmware, or software component operable to generate a 3D model 240 for received input 2D floor plan 230.

The 3D model generator 204 includes an executor component 232 arranged to execute each of the labelled rules 222 for each of a plurality of fixed size portions of the received 2D floor plan 230. Received floor plan 230 can be divided into such fixed size portions using a divider 208 such as that described above. Notably, application of each rule may require a determination of similarity of a portion of the received floor plan 230 with a cluster 214, such as in the above exemplary rule which specifies “IF current_portion is very similar to the cluster labelled wall . . . ”. Thus, it can be necessary to extract features for a portion of the received floor plan 230, such as by way of a feature extractor 210 as described above, in order that the similarity of the portion to a cluster can be determined.

The executor 232 of the 3D model generator 204 thus classifies pixels in each portion of the received floor plan 230 to types of building element based on the labelled rules 222. A rule 222 that is satisfied by a pixel in a portion of the received floor plan 230 are classified to building elements according to a label 216 associated with the rule 222. Where multiple rules 222 are satisfied, a most frequent label 216 can be selected, for example.

The 3D model generator further includes an associator component 234 for associating parts of the received floor plan 230 with a type of building element based on identification of groups of pixels classified as the type of building element. Subsequently, a generator component 236 generates a 3D data model 240 indicating building elements based on the classification of each pixel in the received 2D floorplan 230.

In some embodiments, the 3D data model 240 is constituted as a data file formatted according to the International Foundation Classes (IFC) format, such as may be used to define a Building Information Model (BIM).

In some embodiments, the 3D model 240 is rendered by an extended reality (XR) system such as a virtual reality (VR) system, an augmented reality (AR) system and/or a mixed reality (MR) system.

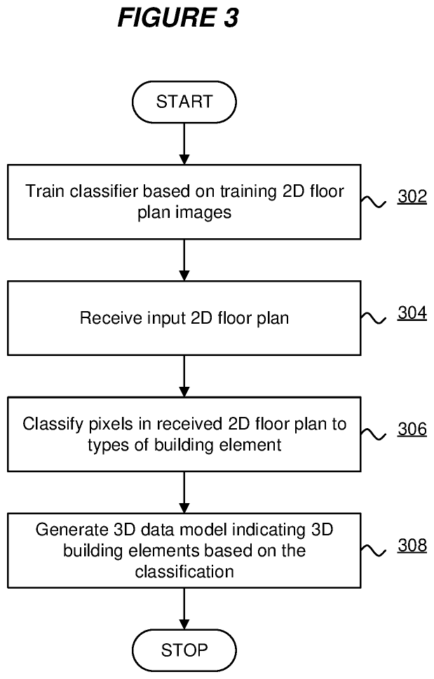

FIG. 3 is a flowchart of a method for generating a three-dimensional (3D) data model of a two-dimensional (2D) floor plan according to embodiments of the present disclosure. Initially, at 302, the method trains a classifier 202 based on training 2D floor plan images 206. At 304 the method receives an input 2D floor plan 230 and at 306 the method classifies pixels in the received floor plan 230 to types of building element. At 308 the method generates a 3D data model 240 indicating 3D building elements based on the classification.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the claims.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method to generate a three-dimensional (3D) data model of a two-dimensional (2D) floor plan, the 2D floor plan being constituted as a digital image including indications of types of building elements, the method comprising:
training a classifier to classify each pixel in each of a plurality of portions of the 2D floor plan to a type of building element, the classifier being defined based on a training set of 2D floor plan images by extracting features for each of a plurality of portions of each 2D floor plan image in the training set and clustering the extracted features to labeled clusters, each label of the labeled clusters indicating a type of building element, wherein training the classifier further comprises defining a plurality of rules defining relationships between pixels in portions of a plan to each cluster by a degree of membership, the relationships being determined based on executing the plurality of rules for pixels in portions of the training set;
receiving a 2D floor plan;
classifying pixels in the received 2D floor plan to types of building elements based on the trained classifier by executing the plurality of rules for each pixel of each of a plurality of portions of the received 2D floor plan to classify the pixel as a type of building element;
associating parts of the received 2D floor plan with each of a plurality of types of building element by identifying groups of pixels classified as the type of building element; and
generating a 3D data model indicating 3D building elements based on the classification of each pixel in the received 2D floor plan.

2. The method of claim 1, wherein the 2D floor plan further includes indications of objects located within a building represented by the 2D floor plan.

3. The method of claim 1, wherein the 3D data model is constituted as a data file formatted according to the International Foundation Classes (IFC) format.

4. The method of claim 3, wherein the 3D data model is used to define a Building Information Model (BIM).

5. The method of claim 1, further comprising rendering the 3D data model by an extended reality system including one or more of: a virtual reality system; an augmented reality system; or a mixed reality system.

6. The method of claim 1, wherein the types of building elements include: wall; window; and door.

7. A computer system comprising:
a processor and memory storing computer program code for generating a three-dimensional (3D) data model of a two-dimensional (2D) floor plan, the 2D floor plan being constituted as a digital image including indications of types of building elements, by:
training a classifier to classify each pixel in each of a plurality of portions of the 2D floor plan to a type of building element, the classifier being defined based on a training set of 2D floor plan images by extracting features for each of a plurality of portions of each 2D floor plan image in the training set and clustering the extracted features to labeled clusters, each label of the labeled clusters indicating a type of building element, wherein training the classifier further comprises defining a plurality of rules defining relationships between pixels in portions of a plan to each cluster by a degree of membership, the relationships being determined based on executing the plurality of rules for pixels in portions of the training set;
receiving a 2D floor plan;
classifying pixels in the received 2D floor plan to types of building elements based on the trained classifier by executing the plurality of rules for each pixel of each of a plurality of portions of the received 2D floor plan to classify the pixel as a type of building element;
associating parts of the received 2D floor plan with each of a plurality of types of building element by identifying groups of pixels classified as the type of building element; and
generating a 3D data model indicating 3D building elements based on the classification of each pixel in the received 2D floor plan.

8. A non-transitory computer readable storage medium comprising computer program code to, when loaded into a computer system and executed thereon, cause the computer system to generate a three-dimensional (3D) data model of a two-dimensional (2D) floor plan, the 2D floor plan being constituted as a digital image including indications of types of building elements, by:
training a classifier to classify each pixel in each of a plurality of portions of the 2D floor plan to a type of building element, the classifier being defined based on a training set of 2D floor plan images by extracting features for each of a plurality of portions of each 2D floor plan image in the training set and clustering the extracted features to labeled clusters, each label of the labeled clusters indicating a type of building element, wherein training the classifier further comprises defining a plurality of rules defining relationships between pixels in portions of a plan to each cluster by a degree of membership, the relationships being determined based on executing the plurality of rules for pixels in portions of the training set;
receiving a 2D floor plan;
classifying pixels in the received 2D floor plan to types of building elements based on the trained classifier by executing the plurality of rules for each pixel of each of a plurality of portions of the received 2D floor plan to classify the pixel as a type of building element;
associating parts of the received 2D floor plan with each of a plurality of types of building element by identifying groups of pixels classified as the type of building element; and
generating a 3D data model indicating 3D building elements based on the classification of each pixel in the received 2D floor plan.
